(19) United States
(12) Patent Application Publication
(10) Pub. No.: US 2024/0428105 A1
(43) Pub. Date: Dec. 26, 2024

(54) Generation and Suggestion of Ranked Ansatz-Hardware Pairings for Variational Quantum Algorithms

(71) Applicant: International Business Machines Corporation, Armonk, NY (US)

(72) Inventors: Anupama RAY, Bangalore (IN); Kalyan DASGUPTA, Bengaluru (IN); SheshaShayee K RAGHUNATHAN, Bangalore (IN); Dhinakaran VINAYAGAMURTHY, Erode (IN); Dhiraj MADAN, New Delhi (IN)

(21) Appl. No.: 18/341,431

(22) Filed: Jun. 26, 2023

(51) Int. Cl. G06N 10/20

(52) U.S. Cl. CPC G06N 10/20

(57) ABSTRACT

One or more systems, computer program products and/or computer-implemented methods of use provided herein relate to a process to generate an ansatz-hardware pairing. A system can comprise a memory that stores computer executable components, and a processor that executes the computer executable components stored in the memory, wherein the computer executable components can comprise a machine learning model that compares inputs to a database of stored ansatz-hardware pairings and that generates the ansatz-hardware pairing based on the comparing, wherein the inputs comprise desired ansatz metrics, defining a variational quantum algorithm, and hardware metrics of quantum hardware available to operate a quantum circuit defined by the ansatz, and a generating component that determines a prediction comprising the ansatz-hardware pairing, wherein the prediction comprises a predicted accuracy of an output of the quantum circuit to be performed on the quantum hardware of the ansatz-hardware pairing.

### TECHNICAL FIELD

The present disclosure relates to generation and suggestion of ranked ansatz-hardware pairings, where the ansatz refers to a quantum circuit configuration, and more specifically to generation and suggestion of ranked ansatz-hardware pairings for variational quantum algorithms (VQAs).

### BACKGROUND

With current advances in quantum engineering and in the quantum field generally, parameterized or variational quantum algorithms are being more widely used. The parameter sub-space for this type of algorithm is exceedingly large and comprises an abundance of variables. Selection of variables can be costly in terms of time, energy, number of quantum device iterations executed, memory, bandwidth and/or the like. As a result, selected parameters are often those that are not best-performing, relative to the hardware configuration on which a quantum circuit is being run.

### SUMMARY

The following presents a summary to provide a basic understanding of one or more embodiments described herein. This summary is not intended to identify key or critical elements, and/or to delineate scope of particular embodiments or scope of claims. Its sole purpose is to present concepts in a simplified form as a prelude to the more detailed description that is presented later. In one or more embodiments described herein, systems, computer-implemented methods, apparatuses and/or computer program products can provide a process to generate and/or suggest one or more sets of ansatz-hardware pairings, such as in a ranked format, for operation of a quantum circuit based on an ansatz corresponding to the pairings on quantum hardware also corresponding to the pairings.

As used herein, an ansatz refers to a quantum circuit configuration that can be based on one or more ansatz metrics such as, but not limited to, selected quantum circuit parameters (e.g., frequency, phase, envelope, duration and/or amplitude), quantum gates of the quantum circuit and/or a qubit mapping for executing the quantum circuit. As used herein, the hardware refers to a hardware configuration on which a quantum circuit can be executed, with the hardware configuration being based on one or more hardware metrics such as, but not limited to, the physical qubits, the physical qubit layout, connectors, substrates and/or inherent hardware noises. Accordingly, as used herein an ansatz-hardware pairing refers to a matching of an ansatz and a hardware configuration that function well together to achieve a best performance of the quantum circuit at a quantum device comprising the hardware configuration. As used herein, a best performance can refer to, but is not limited to, that which has reduced noise, increased measurement precision and/or increased measurement accuracy as compared to other ansatz-hardware pairings.

In accordance with an embodiment, a system can comprise a memory that stores computer executable components, and a processor that executes the computer executable components stored in the memory, wherein the computer executable components can comprise a machine learning model that compares inputs to a database of stored ansatz-hardware pairings and that generates the ansatz-hardware pairing based on the comparing, wherein the inputs comprise desired ansatz metrics, defining a variational quantum algorithm, and hardware metrics of quantum hardware available to operate a quantum circuit defined by the ansatz, and a generating component that determines a prediction comprising the ansatz-hardware pairing, wherein the prediction comprises a predicted accuracy of an output of the quantum circuit to be performed on the quantum hardware of the ansatz-hardware pairing.

In accordance with another embodiment, a computer-implemented method can comprise comparing, by a machine learning model of a system operatively coupled to a processor, inputs to a database of stored ansatz-hardware pairings, wherein the inputs comprise desired ansatz metrics, defining a variational quantum algorithm, and hardware metrics of quantum hardware available to operate a quantum circuit defined by the ansatz; generating, by the machine learning model, the ansatz-hardware pairing based on the comparing; and determining, by the system, a prediction comprising the ansatz-hardware pairing, wherein the prediction comprises a predicted accuracy of an output of the quantum circuit to be performed on the quantum hardware of the ansatz-hardware pairing.

In accordance with yet another embodiment, a computer program product providing a process to generate an ansatz-hardware pairing can comprise a computer readable storage medium having program instructions embodied therewith, the program instructions executable by a processor to cause the processor to compare, by a machine learning model operatively coupled to the processor, inputs to a database of stored ansatz-hardware pairings, wherein the inputs comprise desired ansatz metrics, defining a variational quantum algorithm, and hardware metrics of quantum hardware available to operate a quantum circuit defined by the ansatz; generate, by the machine learning model, the ansatz-hardware pairing based on the comparing; and determine, by the processor, a prediction comprising the ansatz-hardware pairing, wherein the prediction comprises a predicted accuracy of an output of the quantum circuit to be performed on the quantum hardware of the ansatz-hardware pairing.

A benefit of the above-indicated system, computer-implemented method and/or computer program product can be allowing for an automatic process for identifying both ansatz metrics and hardware metrics that pair well, and thus result in a chosen trade off of hardware, number of shots to run, monetary cost and/or accuracy of output. That is, varied output, e.g., pairing predictions, can be provided, and from these outputs, a pairing can be identified for operation that satisfies selected requirements for operation among the available hardware, number of shots to run, monetary cost and/or accuracy of output. A balance of these trade off aspects can be identified automatically, based on selected input to the system and/or by a user entity.

As used herein, accuracy of results can refer to results as compared to simulator results (e.g., that are free of noise). That is, all quantum machines inherently produce some level of device-initiated noise. This noise can be altered by a quantum circuit being operation on a respective quantum machine. The resultant noise can affect overall amount of noise comprised by the output and error in the output, e.g., as compared to a noise-free operation.

Indeed, determining a good match of hardware for an ansatz can be difficult. Even where parameters of a VQA are well-chosen for operation of the ansatz itself, such parameters themselves often do not match well with a chosen hardware configuration (e.g., hardware configuration on which the VQA is chosen to be operated as a quantum circuit based on the VQA). As such, a benefit of the above-indicated system, computer-implemented method and/or computer program product can be output of at least one ansatz-hardware pairing prediction based on available input to the above-indicated system, computer-implemented method and/or computer program product.

For example, a user entity can input ansatz metrics such as VQA parameters, chosen quantum gates for a quantum circuit defined by the VQA and/or a proposed qubit mapping. The user entity further can input hardware metrics for one or more machines that can be available for operation of the quantum circuit. As used herein, availability can be based on available operation time, allowable level of access, cost to access (e.g., budget), etc. Indeed, even with minimal access to one or more quantum devices/systems, the one or more quantum devices/systems can have plural available configurations, and the one or more embodiments described herein can enable pairing outputs that can result in a more efficient use of the quantum hardware, reduced load on the quantum hardware, increased productivity of experiments by a user entity and/or increased number of experiments operated by a user entity.

### DESCRIPTION OF THE DRAWINGS

FIG. 1 illustrates a block diagram of an example, non-limiting system that can provide a process to generate an ansatz-hardware pairing, in accordance with one or more embodiments described herein.

FIG. 2 illustrates a block diagram of another example, non-limiting system that can provide a process to generate an ansatz-hardware pairing, in accordance with one or more embodiments described herein.

FIG. 3 illustrates a block diagram of a non-limiting system comprising a quantum system and a classical system of the non-limiting system of FIG. 2, in accordance with one or more embodiments described herein.

FIG. 4 illustrates a block diagram of inputs to the ansatz and hardware pairing system of FIG. 2 of an example, in accordance with one or more embodiments described herein.

FIG. 5 illustrates a block diagram a process for generating an ansatz-hardware pairing by an ansatz and hardware pairing system of FIG. 2 of an example, in accordance with one or more embodiments described herein.

FIG. 6 depicts a block flow diagram of a process for generating data for storage at a database employed by a machine learning model of an ansatz and hardware pairing system of FIG. 2, in accordance with one or more embodiments described herein.

FIG. 7 illustrates a set of data of the database of FIG. 6, in accordance with one or more embodiments described herein. FIG. 7 also illustrates primary and final data sets that can be output by the non-limiting system of FIG. 2, in accordance with one or more embodiments described herein.

FIG. 8 illustrates a flow diagram of one or more processes that can be performed by an ansatz and hardware pairing system of FIG. 2, in accordance with one or more embodiments described herein.

FIG. 9 illustrates a continuation of the flow diagram of FIG. 8, of one or more processes that can be performed by an ansatz and hardware pairing system of FIG. 2, in accordance with one or more embodiments described herein.

FIG. 10 illustrates a block diagram of a non-limiting, computer environment, in accordance with one or more embodiments described herein.

### DETAILED DESCRIPTION

The following detailed description is merely illustrative and is not intended to limit embodiments and/or application or utilization of embodiments. Furthermore, there is no intention to be bound by any expressed or implied information presented in the preceding Summary section, or in the Detailed Description section. One or more embodiments are now described with reference to the drawings, wherein like reference numerals are utilized to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Generally, use of a VQA for a quantum application can involve determination of a plurality of parameters for the VQA and thus for a respective quantum circuit (based on the VQA) being operated on a quantum device. As indicated above, the parameter sub-space for this type of algorithm is exceedingly large and comprises an abundance of variables. Selection of variables can be costly in terms of time, energy, number of quantum device iterations executed, memory, bandwidth and/or the like. As a result, parameters selected via existing frameworks are often those that are not best-performing, relative to the hardware configuration on which a quantum circuit is being run.

For example, existing frameworks can comprise heuristically choosing parameters for a quantum circuit based on a VQA, which parameters are chosen to manipulate the states of the qubits being operated upon. As used herein, the term heuristically refers to there being no particular closed form for selecting the parameters, but rather that selection is based on experience, trial and error. For example, existing frameworks can comprise running a plurality of quantum circuits for different parameters, with each parameter being employed for a plurality of respective shots. Further, even when a simulator is employed, results can be different from real-world results when certain types of hardware or certain hardware configurations are simulated. As is often the case, not all hardware is able to be simulated and hardware that can be simulated often is not simulated exactly as the real-world hardware counterpart. Each of these deficiencies can lead to inaccurate results output from an experiment such as due to noise and/or error. The error can be caused by noise and/or mismatch between the ansatz and hardware of a pairing.

That is, existing frameworks do not consider the hardware or configuration of the hardware on which the quantum circuit defined by the VQA will be run. Indeed, the VQA parameters can affect qubit mapping, which is based on the available qubit layout of the quantum device being operated upon. The VQA parameters and the qubit mapping each are ansatz metrics that can function better with some hardware configurations than with others. For example, consideration of such qubit layout can include at least consideration of different interconnectivities, types of qubits, and more generally, the quantum processor topology of the respective quantum device. Lack of such consideration can lead to increased noise, loss of precision of measurements and/or loss of accuracy of measurements when operating a quantum circuit at the respective quantum device.

To account for one or more of the aforementioned deficiencies of existing frameworks for selecting a pairing of an ansatz and respective hardware, e.g., for selection of ansatz-hardware pairings, one or more embodiments described herein provide a system, computer-implemented method and/or computer program product that can aid an entity in automatic selection of the ansatz-hardware pairing for operation of a particular quantum algorithm as a particular quantum circuit at a particular quantum device having a particular hardware configuration. That is generally, the one or more embodiments described herein can provide an approach for selecting an ansatz-hardware pairing for a problem, with consideration of metrics related to the ansatz, metrics related to hardware to be used to solve the problem, and user constraints such as budget, hardware access (what hardware configurations are available), topology of hardware, and inherent hardware noise.

As used herein, the terms “entity”, “requesting entity”, and “user entity” can refer to a machine, device, component, hardware, software, smart device and/or human.

The one or more embodiments described herein can provide generation of an ansatz-hardware pairing database have varied pairings such as to provide coverage of a hypercube representee pairings. The one or more embodiments described herein further can provide training of a machine learning (ML) model based on the database, where the trained ML model can compare input ansatz metrics, hardware metrics and/or other user entity-specified constraints to data of the database and output a prediction of one or more ansatz-hardware pairings for use based on the inputs and on the comparing. The prediction can comprise any one or more of a predicted accuracy of output of operation of the ansatz (and thus of a quantum circuit based on the ansatz), monetary cost of operation of the ansatz, and/or values for expressibility of the ansatz and/or for entanglement of states corresponding to the quantum circuit. The one or more embodiments described herein also can rank the one or more ansatz-hardware pairing predictions based on any one or more different ranking aspects, such as number of shots to be run, monetary cost, topology, machine type and/or output accuracy. These insights through ranking can allow a user entity evaluating the predicted ansatz-hardware pairings to determine a best trade off based on user entity-based subjective criteria.

It follows that the one or more embodiments described herein can enable improved performance of a quantum system executing quantum circuit based on an ansatz-hardware pairing output from the one or more embodiments described herein. That is, an ansatz can be matched to a hardware configuration on which the ansatz runs well, e.g., with reduced noise and/or error as compared to operation one or more other hardware configurations.

Put another way, by automatically determining an ansatz-hardware pairing, one or more of the following can be achieved: a more efficient use of the quantum hardware, a reduced load on the quantum hardware, an increased productivity of efficient and high accuracy experiments, and/or an increased number of experiments operated by a user entity can be obtained. A more efficient use of quantum hardware can refer to where qubits do not go unused or qubit coherency time is not wasted. A reduced load on quantum hardware can refer to fewer shots being run or fewer calibrations due to better ansatz and hardware alignment (e.g., pairing). An increased productivity of experiments can refer to achieving outputs with reduced noise, reduced error and/or higher accuracy of the variational quantum algorithm (or other type of algorithm if being employed). An increased number of experiments operated by a user entity can correspond to fewer noise and/or error issues causing wasted shots and/or lost qubit coherency time, and/or can refer to reduction in shots and/or calibrations due to better ansatz and hardware alignment (e.g., pairing). Indeed, a balance of two or more of these benefits can be obtained by provision of two or more ansatz-hardware pairing from which a desired pairing satisfying such balance can be selected.

As used herein, the term “cost” can refer to money, power, memory, bandwidth, time and/or the like.

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident in various cases, however, that the one or more embodiments can be practiced without these specific details.

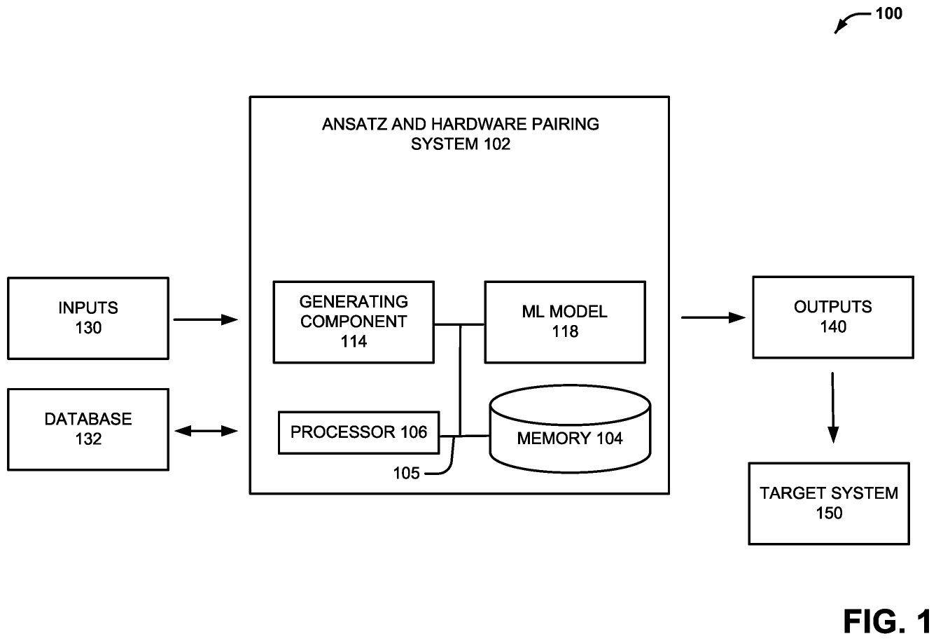

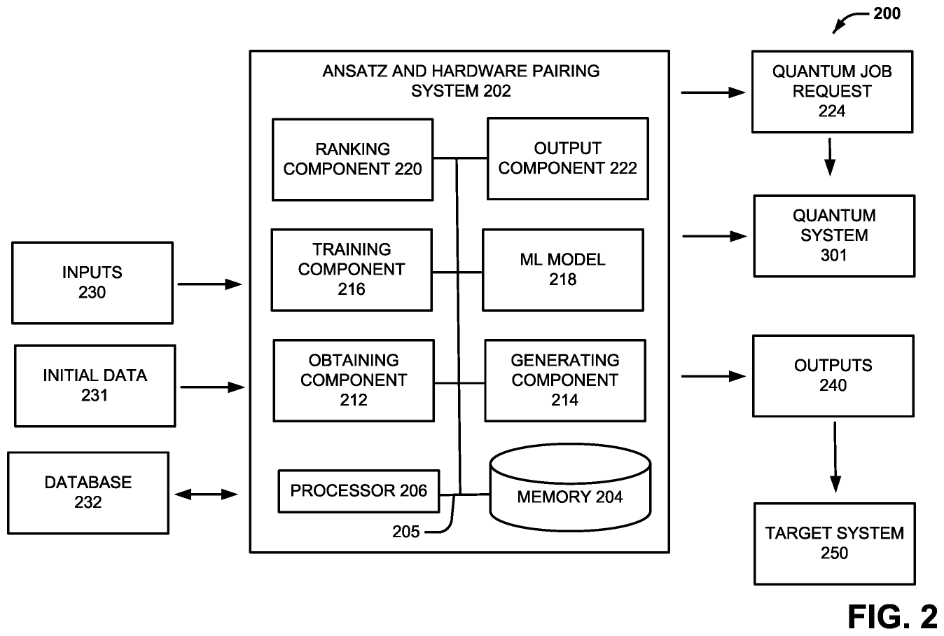

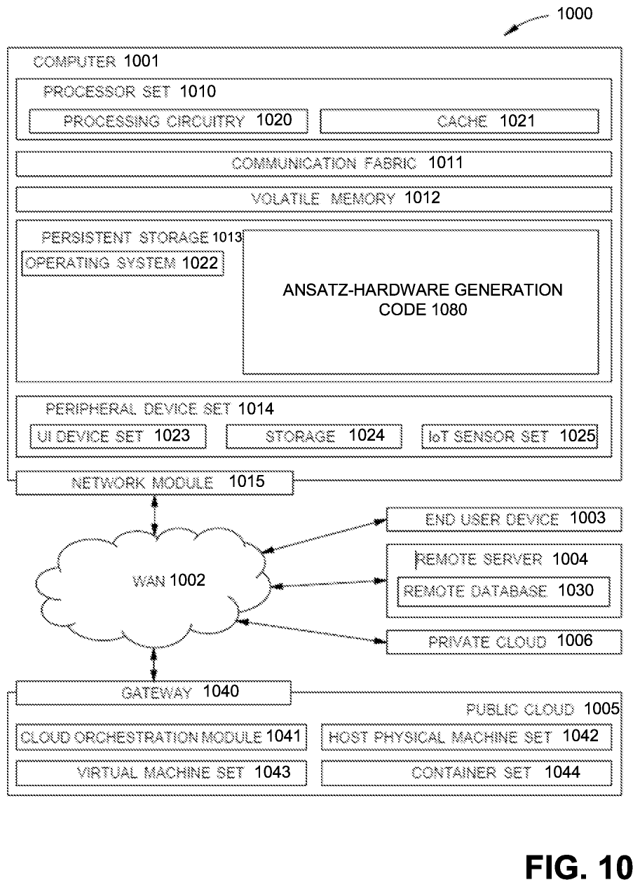

Further, it should be appreciated that the embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems 100, 200 and/or 300 illustrated at FIGS. 1, 2 and/or 43 and/or systems thereof, can further comprise one or more computer and/or computing-based elements described herein with reference to a computing environment, such as the computing environment 1000 illustrated at FIG. 10. In one or more described embodiments, computer and/or computing-based elements can be used in connection with implementing one or more of the systems, devices, components and/or computer-implemented operations shown and/or described in connection with FIGS. 1, 2 and/or 3 and/or with other figures described herein.

Turning now in particular to FIG. 1, the figure illustrates a block diagram of an example, non-limiting system 100 that can facilitate pairing of ansatz metrics and hardware metrics to allow for automatic output of one or more predicted (e.g., suggested) ansatz-hardware pairings, in accordance with one or more embodiments described herein.

The non-limiting system 100 can comprise an ansatz and hardware pairing system 102, which can be associated with a cloud computing environment. The ansatz and hardware pairing system 102 can comprise one or more components, such as a memory 104, processor 106, bus 105, generating component 114 and/or machine learning model 118. Generally, ansatz and hardware pairing system 102, and thus non-limiting system 100, can facilitate the automatic output of the one or more predicted ansatz-hardware pairings.

The machine learning (ML) model 118 can compare inputs 230 to a database 232 of stored ansatz-hardware pairings. Based on the comparing, the ML model 218 can generate an ansatz-hardware pairing. The inputs 230 can comprise desired ansatz metrics, defining a variational quantum algorithm, and hardware metrics of quantum hardware available to operate a quantum circuit defined by the ansatz. The generating component 114 can determine a prediction comprising the ansatz-hardware pairing, based on the output of the ML model 118. The prediction can comprise at least a prediction accuracy of an output of the quantum circuit to be performed on the quantum hardware of the ansatz-hardware pairing. As mentioned above, as used herein, accuracy of results can refer to results as compared to simulator results (e.g., that are free of noise). That is, all quantum machines inherently produce some level of device-initiated noise. This noise can be altered by a quantum circuit being operation on a respective quantum machine. The resultant noise can affect overall amount of noise comprised by the output and error in the output, e.g., as compared to a noise-free operation.

It is noted that the above description is provided merely as an introduction to the one or more embodiments described herein, and that a more detailed description of an ansatz and hardware pairing system is provided below, with reference to at least claims 2 and 3.

Turning next to FIG. 2, a non-limiting system 200 is illustrated that can comprise an ansatz and hardware pairing system 202. Repetitive description of like elements and/or processes employed in respective embodiments is omitted for sake of brevity. Description relative to an embodiment of FIG. 1 can be applicable to an embodiment of FIG. 2. Likewise, description relative to an embodiment of FIG. 2 can be applicable to an embodiment of FIG. 1.

One or more communications between one or more components of the non-limiting system 200 can be provided by wired and/or wireless means including, but not limited to, employing a cellular network, a wide area network (WAN) (e.g., the Internet), and/or a local area network (LAN). Suitable wired or wireless technologies for supporting the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an advanced and/or adaptive network technology (ANT), an ultra-wideband (UWB) standard protocol and/or other proprietary and/or non-proprietary communication protocols.

The ansatz and hardware pairing system 202 can be associated with, such as accessible via, a cloud computing environment.

The ansatz and hardware pairing system 202 can comprise a plurality of components. The components can comprise a memory 204, processor 206, bus 205, obtaining component 212, generating component 214, training component 216, ML model 218, ranking component 220 and/or output component 222.

Generally, the ansatz and hardware pairing system 202 can facilitate pairing of ansatz metrics and hardware metrics to allow for automatic output of one or more predicted (e.g., suggested) ansatz-hardware pairings, in accordance with one or more embodiments described herein.

Discussion first turns briefly to the processor 206, memory 204 and bus 205 of the ansatz and hardware pairing system 202. For example, in one or more embodiments, the ansatz and hardware pairing system 202 can comprise the processor 206 (e.g., computer processing unit, microprocessor, classical processor, quantum processor and/or like processor). In one or more embodiments, a component associated with ansatz and hardware pairing system 202, as described herein with or without reference to the one or more figures of the one or more embodiments, can comprise one or more computer and/or machine readable, writable and/or executable components and/or instructions that can be executed by processor 206 to provide performance of one or more processes defined by such component(s) and/or instruction(s). In one or more embodiments, the processor 206 can comprise the obtaining component 212, generating component 214, training component 216, ML model 218, ranking component 220 and/or output component 222.

In one or more embodiments, the ansatz and hardware pairing system 202 can comprise the computer-readable memory 204 that can be operably connected to the processor 206. The memory 204 can store computer-executable instructions that, upon execution by the processor 206, can cause the processor 206 and/or one or more other components of the ansatz and hardware pairing system 202 (e.g., obtaining component 212, generating component 214, training component 216, ML model 218, ranking component 220 and/or output component 222) to perform one or more actions. In one or more embodiments, the memory 204 can store computer-executable components (e.g., obtaining component 212, generating component 214, training component 216, ML model 218, ranking component 220 and/or output component 222).

The ansatz and hardware pairing system 202 and/or a component thereof as described herein, can be communicatively, electrically, operatively, optically and/or otherwise coupled to one another via a bus 205. Bus 205 can comprise one or more of a memory bus, memory controller, peripheral bus, external bus, local bus, quantum bus and/or another type of bus that can employ one or more bus architectures. One or more of these examples of bus 205 can be employed.

In one or more embodiments, the ansatz and hardware pairing system 202 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical and/or quantum computing devices, communication devices and/or like devices), such as via a network. In one or more embodiments, one or more of the components of the ansatz and hardware pairing system 202 and/or of the non-limiting system 200 can reside in the cloud, and/or can reside locally in a local computing environment (e.g., at a specified location(s)).

In addition to the processor 206 and/or memory 204 described above, the ansatz and hardware pairing system 202 can comprise one or more computer and/or machine readable, writable and/or executable components and/or instructions that, when executed by processor 206, can provide performance of one or more operations defined by such component(s) and/or instruction(s).

Turning now to the additional components of the ansatz and hardware pairing system 202 (e.g., obtaining component 212, generating component 214, training component 216, ML model 218, ranking component 220 and/or output component 222), generally, the ansatz and hardware pairing system 202 can facilitate the automatic output of one or more predicted ansatz-hardware pairings.

Turning first to the obtaining component 212, this component can identify, search, receive, transfer and/or otherwise obtain the inputs 230 and/or initial data 231 for generating the database 232. Where the database 232 is already generated, the obtaining component likewise can identify, search, receive, transfer and/or otherwise obtain data from the database 232.

The inputs 230 comprise information (e.g., data and/or metadata) associated with a user entity that is looking to employ the ansatz and hardware pairing system 202 to generate an ansatz-hardware pairing based on the inputs 230. That is, the inputs 230 can generally define an ansatz for defining a quantum circuit to be run on quantum hardware (e.g., the quantum system 301) to solve a problem expressed by the ansatz.

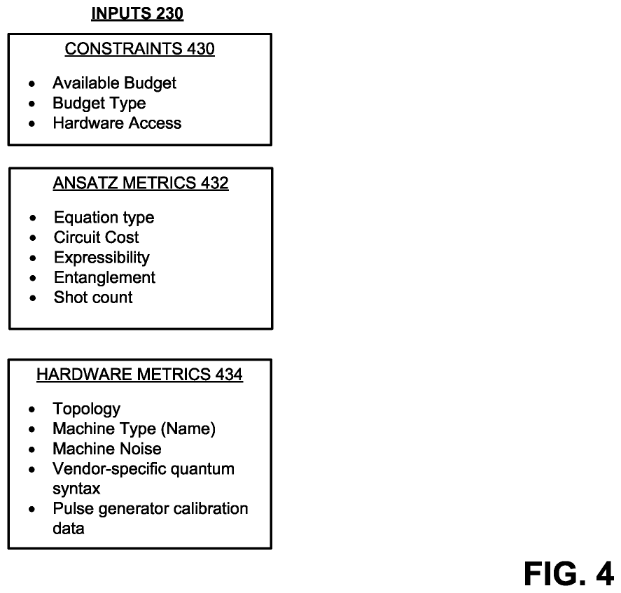

For example, turning to FIG. 4, in addition still to FIG. 2, the inputs 230 can comprise constraints 430, ansatz metrics 432 and/or hardware metrics 434, without being limited thereto.

Constraints 430 can comprise an available monetary budget, a budget type (e.g., whether the experiment can be performed all at once or piecemeal), and hardware access. That is, a user entity looking to solve a problem using an ansatz and quantum hardware to operate the ansatz can have access to a limited/finite number of quantum hardwares (e.g., quantum system 301) and/or a limited/finite number of quantum hardware configurations.

Ansatz metrics 432 can generally define the problem that the user entity is looking to solve using the ansatz and quantum hardware to operate the ansatz. These ansatz metrics 432 can comprise equation type, circuit cost, expressibility, entanglement and/or shot count, without being limited thereto.

Regarding equation type, while reference herein is often made to a variational quantum algorithm (VQA), the one or more embodiments likewise function for other classification algorithms, such as variation quantum classifier (VQC), quantum neural network (QNN) and/or quantum-enhanced support vector machine (QSVM).

Expressibility of an ansatz is defined as a quantitative measurement of a number of states generatable by the ansatz. That is, higher expressibility correlates to a higher number of states that can be generated by an ansatz (e.g., quantum states).

Entanglement of an ansatz is defined as a matrix of the entangled states. That is, measurement of one state can be correlated with measurements of one or more other states, created entanglement. A balance of entanglement can aid in constraining a space of the ansatz by limiting the correlated states.

Shot count refers to the number of shots that need to be operated to obtain a desired outcome from the ansatz.

Finally, circuit cost can refer to a function of circuit depth, number of single and multiple qubit gates, noise models, expressibility and/or an entanglement cap.

The hardware metrics 434 can comprise hardware topology, hardware name (e.g., machine name), hardware type, hardware noise (e.g., machine noise), vendor specific quantum syntax, pulse generator calibration data and/or the like. That is, these metrics can define the hardware configuration of a hardware which can have one or more different configurations. For example, a topology can comprise all or only a subset of available qubits, qubits can be of different types, different types of physical couplings can be employed, different qubits can be coupled to and/or not couple to one another, different qubits can be operated upon by different pulse generators and/or the like.

Referring next to data of the database 232 and/or initial data 231 for generating and/or adding to the database 232 that can be obtained by the obtaining component 212, such data can comprise information similar to that described above relative to the inputs 230. That is, such information can comprise hypothetical constraints, ansatz metrics and hardware metrics. However, the database 232 is generated prior to use of the inputs 230, which inputs 230 are then employed after database generation for operating an iteration of pairing at the ansatz and hardware pairing system 202.

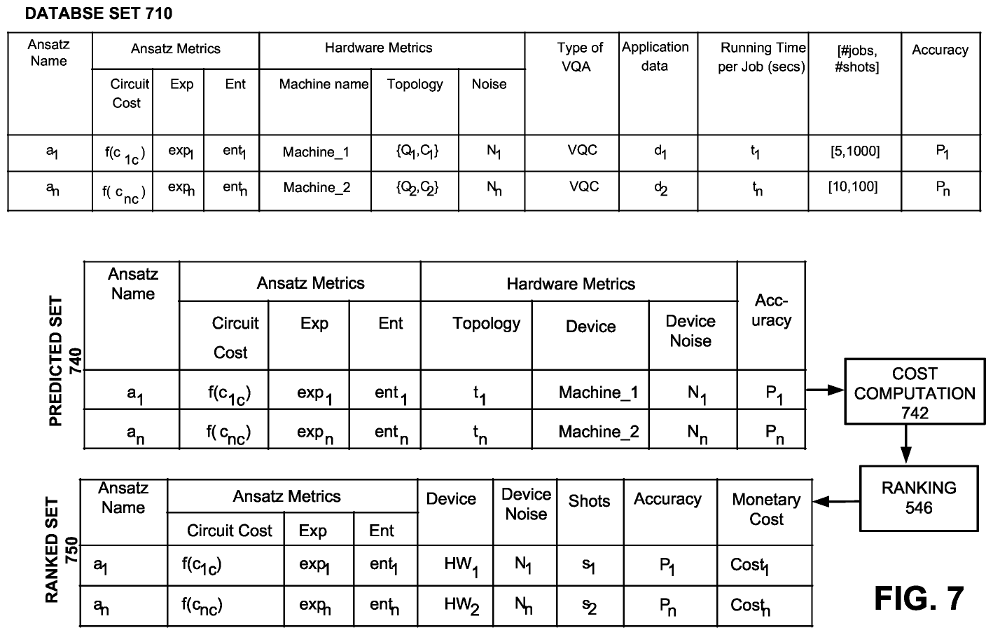

Turning briefly to FIG. 7, an example database set 710 that can be comprised by the database 232 is illustrated as a table. As shown, the database set 710 comprises ansatz metrics, hardware metrics, type of algorithm/equation, data relative to the problem sought to be solved, job run time, number of shots, and finally, an output accuracy of results of the ansatz-hardware pairing of the respective row. That is, the database 232 can comprise a plurality of example ansatz-hardware pairings (illustrated as separate rows) for use in comparison to the input data by the ansatz and hardware pairing system 202 to generate one or more predicted ansatz-hardware pairings for use by a user entity in solving the respective problem corresponding to the inputs 230.

Accordingly, discussion now turns first to generation of the database 232, then to training of the ML model 218 that uses the database 232, and finally to use of the ansatz and hardware pairing system 202 (comprising the ML model 218) to provide one or more ansatz-hardware pairings to aid in solving a problem that corresponds to the set of inputs 230.

Referring still to FIG. 2, direction turns to the training component 216. The training component 216 can generally generate the database 232 and/or update the database 232 based on initial ansatz metrics and hardware metrics. Generally, the training component 216 can generate an initial set of ansatz-hardware pairings varied from one another based on different initial ansatz metrics, different initial hardware metrics, or both (e.g., comprised by the initial data 231). To achieve these generations, the training component 216 determines distance values between sample pairs of the ansatz-hardware pairings of the initial set and continues to generate additional ansatz-hardware pairings for the initial set where the distance values fail to satisfy a distance value threshold. The training component 216 further directs evaluation of the ansatz-hardware pairings of the initial set on quantum hardware (e.g., the quantum system 301) defined by the initial hardware metrics or on a simulator defined by the initial hardware metrics. Finally, the training component 216 can store output accuracies corresponding to the operated ansatz-hardware pairings at the database 232 with the respective initial ansatz metrics and initial hardware metrics, thus completing a database information aspect such as the example database set 710 illustrated at FIG. 7.

Briefly, it is noted that the database 232 can be internal and/or external to the ansatz and hardware pairing system 202 but is generally communicatively coupled to the ansatz and hardware pairing system 202 for access to the database 232 by the ansatz and hardware pairing system 202. The database 232 can comprise data and/or metadata in any suitable format (e.g., lists, matrices, tables, graphs and/or the like).

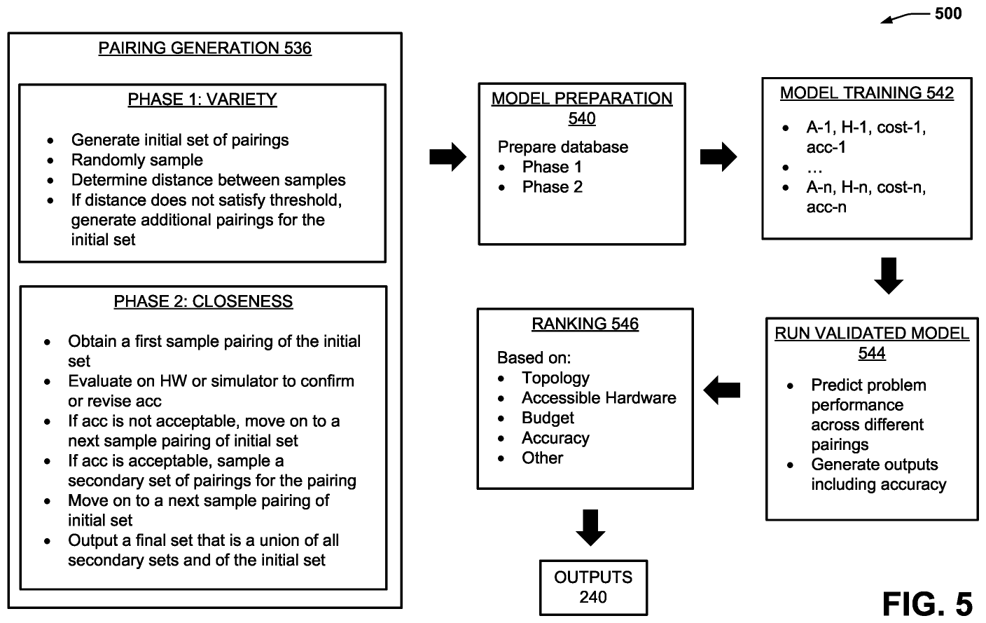

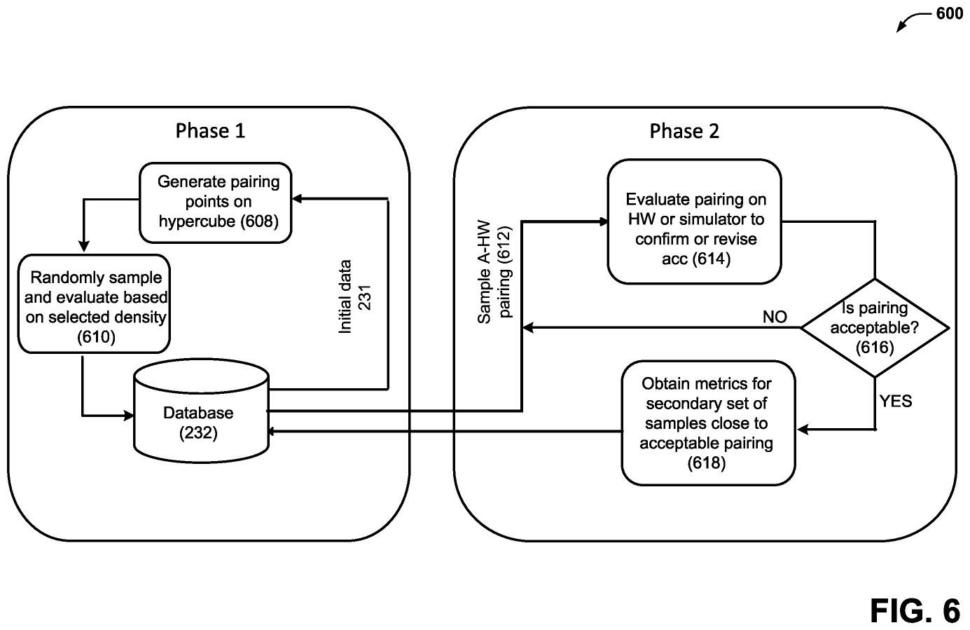

The above-noted processes will now be described in further detail relative to FIGS. 5 and 6.

Turning first to FIGS. 5 and 6, a pairing generation step 536 can be performed by the training component 216 using the initial data 231. Using the pairings of the pairing generation step 536, the training component 216 can perform model preparation 540, which can comprise preparation of the database 232. The model preparation 540 can comprise a first phase and a second phase, each to be performed at least partially by the generating component 214 at the classical ansatz and hardware pairing system 202.

The first phase (Phase 1) can comprise generating an initial set of ansatz-hardware pairings 606 based on the initial data 231 (e.g., at step 608 of the database generation diagram 600 of FIG. 6). The initial set of pairings can be defined as an n-dimensional hypercube A, where n is the number of different metrics (e.g., ansatz metrics, hardware metrics and other constraints).

Phase 1 can further comprise random sampling at step 610, by the training component 216, of a primary subset of the initial set of ansatz-hardware pairings. The training component 216, for each pairing of the primary subset, can determine one or more distances between the respective pairing and other pairings at the hypercube A. For example, a minimum distance, maximum distance, average of distance or other percentage of combined distances can be used. As used herein, distance can be defined as a closeness property, such as a Euclidian distance between pairings defined as coordinates on the hypercube A. The distance can be evaluated against a selected density d₀ of the hypercube A, which density d₀ can serve as a threshold to be met or exceeded. The density d₀ can be varied, can be defined by the user entity, and/or can be a default value set by the training component 216. Where the density d₀ is satisfied by a random pairing of the primary subset, the training component 216 can move on to the next random pairing of the primary subset, and so on, until all random pairings of the primary subset have been evaluated. Where the density d₀ not satisfied by any one random pairing of the primary subset, one or more additional ansatz-hardware pairings can be generated by the training component 216. Depending on initial settings, upon finding any random pairing of the primary subset as failing to satisfy the density d₀, Phase 1 can move immediately again to step 608. Alternatively, the evaluations of the random pairings of the primary subset can continue until all random pairings have been evaluated, and then Phase 1 can move again to step 608.

Accordingly, an output of Phase 1 is an initial set of ansatz-hardware pairings S, such that A is sufficiently covered with a selected density d₀. The initial set is the input into Phase 2. At Phase 2, a secondary subset of the initial set of ansatz-hardware pairings is sampled at step 612, e.g., by the training component 216. The secondary subset is different from the primary subset but can contain one or more pairings that are in each of the primary and secondary subsets. Each sample pairing of the secondary subset is evaluated on quantum hardware (e.g., quantum system 301) that correlates to the hardware metrics of the pairing or on a simulator that simulates the quantum hardware that correlates to the hardware metrics of the pairing. It is noted that the quantum system 301 will be described next, after discussion of Phase 2. The operation on the quantum hardware or simulated operation on a simulator is based on operation of one or more quantum circuits defined by the ansatz metrics of the pairing of the secondary subset. The operation is performed to confirm or to revise the results accuracy of the pairing.

In connection with the confirmation/revision to the accuracy, the resultant accuracy resulting from the operation is compared against an accuracy threshold. The accuracy threshold is satisfied where the resultant accuracy meets or exceeds the accuracy threshold, for example. Determination of resultant accuracy acceptability (e.g., as step 616) can be made by the training component 216 and/or by the ML model 218, to be described briefly next.

As illustrated at FIG. 2, the ansatz and hardware pairing system 202 can comprise an analytical model, such as the ML model 218. In one or more other embodiments, the ML model 218 can comprise and/or can be comprised by a classical model, predictive model, neural network, and/or artificial intelligent model. An artificial intelligent model and/or neural network (e.g., a convolutional network and/or deep neural network) can comprise and/or employ artificial intelligence (AI), machine learning (ML), and/or deep learning (DL), where the learning can be supervised, self-supervised, semi-supervised and/or unsupervised. The ML model 218 can be trained based on the data of the database 232, which database 232, as described above, can be generated by the training component 216 and may employ the ML model 218 for the generation.

In one or more embodiments, the ML model 218 can be a supervised neural network classifier which can be trained, e.g., by the training component 216, on a database created by all job details and logs, where jobs refer to quantum programs being run on real quantum hardware. The ML model 218 can obtain inputs from a job (e.g., an iteration of use) including the variational quantum algorithm type (or other algorithm type if being used), the ansatz being used, and/or the hardware in consideration (including topology and noise of the hardware). Along with these features from each job, the ML model 218 can obtain the expressibility of the ansatz and the entangling capacity of the ansatz as additional inputs. The ML model 218 can learn the accuracies or other performance metric of the variational quantum algorithm (or other algorithm if being used) given the ansatz and the hardware details. This learned information can be used to predict performance metrics for other ansatz-hardware pairings as per an application.

Where the accuracy threshold is not satisfied by a pairing of the secondary subset, the process moves on to the next pairing of the secondary subset. Where the accuracy threshold is satisfied by a pairing of the secondary subset, the pairing is added to a set of pairings Sᵢ₋₁^{out} (e.g., a secondary set) which performed well. At step 618, the metrics (e.g., ansatz metrics, hardware metrics, other considerations, and/or accuracy) can be obtained and employed for generating a tertiary and final set of ansatz-hardware pairings sin. The evaluation in this way, including the determining of resultant accuracy acceptability, is completed, e.g., by the training component 216 and/or by the ML model 218, for each remaining pairing of the secondary subset.

Finally, for the pairings of the secondary subset that were added to the set of pairings Sᵢ₋₁^{out} (e.g., a secondary set) which performed well, a union is generated of the metrics for these pairings Sᵢ₋₁^{out} and of all pairings. The union Sᵢⁱⁿ, is generated by X. As used herein, a union can be a set of pairings. Accordingly, an output of Phase 2 is a tertiary and final set of ansatz-hardware pairings Sᵢⁱⁿ, which is employed as the data of the database 232, such as the database set 710, for use by the ML model 218 in responding to one or more requests the ansatz and hardware pairing system 202 to predict one or more ansatz-hardware pairings.

This final set of ansatz-hardware pairings sin can be stored at the database 232 and employed by the training component 216 to train the ML model 218 at the model training step 542 of the diagram 500 of FIG. 5. Model training can result in sets of trained data be recognized by and/or stored at the ML model 118 such as corresponding to a format of A-1, H-1, cost-1, acc-1 . . . . A-n, H-n, cost-n, acc-n.

Additional training of the ML model 218, such as relative to new ansatz-hardware pairings (such as due to availability of new types of ansatz, new hardware or new hardware configurations) can be performed periodically and/or at any other frequency. For example, re-training can be performed after each iteration of use of the validated ML model 218.

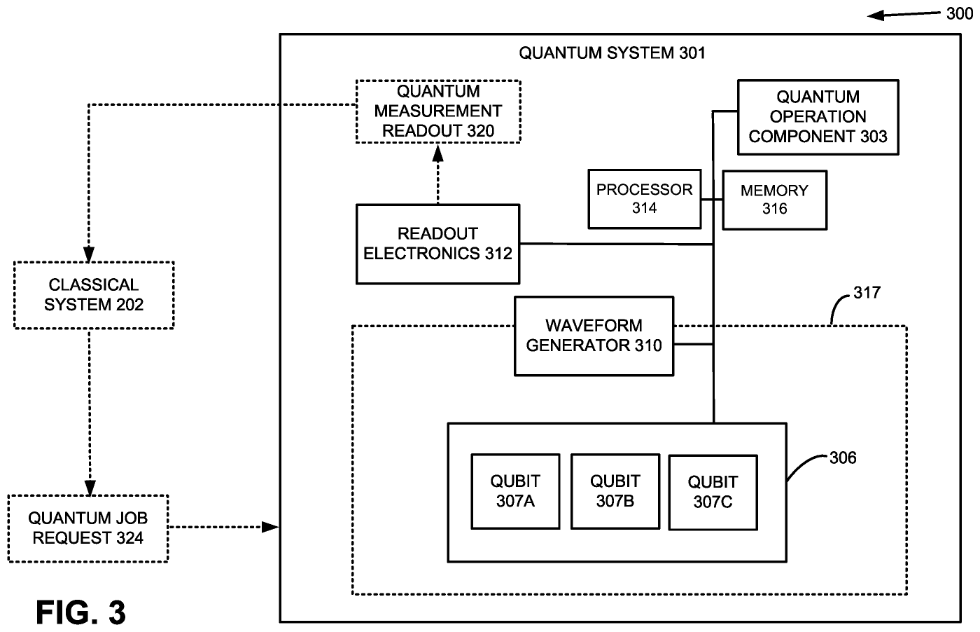

Turning now to FIG. 3, illustrated is a non-limiting system 300 comprising the ansatz and hardware pairing system 202 as a classical system 202 and a quantum system 301. The quantum system 301 can be employed to operate one or more ansatz-hardware pairings to evaluate accuracy of the pairings during Phase 2, as described above. Moreover, the quantum system 301 can be employed to operate a predicted ansatz-hardware pairing output by the ansatz and hardware pairing classical system based on the inputs 230.

As illustrated, the non-limiting system 300 can be a hybrid system and thus can include both a quantum system and a classical system, such as the quantum system 301 and the classical-based system (also herein referred to as a classical system, such as the ansatz and hardware pairing system 202). In one or more embodiments, one or more components of the classical system can be at least partially comprised by the quantum system 301, or otherwise comprised external to the classical system. In one or more embodiments, the ansatz and hardware pairing system 202 and/or one or more components thereof can be comprised by the quantum system 301. In one or more embodiments, one or more components of the quantum system 301, such as the readout electronics 312, can be at least partially comprised by a classical system, or otherwise disposed external to the quantum system 301.

One or more communications between one or more components of the non-limiting system 300 can be provided by wired and/or wireless means including, but not limited to, employing a cellular network, a wide area network (WAN) (e.g., the Internet), and/or a local area network (LAN). Suitable wired or wireless technologies for supporting the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an advanced and/or adaptive network technology (ANT), an ultra-wideband (UWB) standard protocol and/or other proprietary and/or non-proprietary communication protocols.

The ansatz and hardware pairing system 202 and/or the quantum system 301 can be associated with, such as accessible via, a cloud computing environment. For example, the ansatz and hardware pairing system 202 can be associated with a cloud computing environment such that aspects of classical processing can be distributed between the ansatz and hardware pairing system 202 and the cloud computing environment.

Turning now to the quantum system 301, generally based on a quantum job request 324, such as comprising a quantum circuit to be executed, the quantum operation component 303 and/or quantum processor 306 can direct execution of the quantum circuit at the quantum processor 306. In one or more embodiments, the quantum job request 424 can comprise a quantum circuit based on the ansatz metrics of an ansatz-hardware pairing output by the classical ansatz and hardware pairing system 202.

Generally, the quantum system 301 (e.g., quantum computer system, superconducting quantum computer system and/or the like) can employ quantum algorithms and/or quantum circuitry, including computing components and/or devices, to perform quantum operations and/or functions on input data to produce results that can be output to an entity. The quantum circuitry can comprise quantum bits (qubits), such as multi-bit qubits, physical circuit level components, high level components and/or functions. The quantum circuitry can comprise physical pulses that can be structured (e.g., arranged and/or designed) to perform desired quantum functions and/or computations on data (e.g., input data and/or intermediate data derived from input data) to produce one or more quantum results as an output. The quantum results, e.g., quantum measurement readout 320, can be responsive to the quantum job request 324 and associated input data and can be based at least in part on the input data, quantum functions and/or quantum computations.

In one or more embodiments, the quantum system 301 can comprise components, such as a quantum operation component 303, a quantum processor 306, pulse component 310 (e.g., a waveform generator) and/or a readout electronics 312. In one or more other embodiments, the readout electronics 312 can be comprised at least partially by the classical system 202 and/or be external to the quantum system 301. The quantum processor 306 can comprise one or more, such as plural, qubits 307. Individual qubits 307A, 307B and 307C, for example, can be fixed frequency and/or single junction qubits, such as transmon qubits.

The quantum processor 306 can be any suitable processor. The quantum processor 306 can generate one or more instructions for controlling the one or more processes of the quantum operation component 303.

The quantum operation component 303 can obtain (e.g., download, receive, search for and/or the like) a quantum job request 324 requesting execution of one or more quantum programs and/or a physical qubit layout. The quantum job request 324 can be provided in any suitable format, such as a text format, binary format and/or another suitable format. In one or more embodiments, the quantum job request 324 can be obtained by a component other than of the quantum system 301, such as a by a component of the classical system 202.

In one or more embodiments, a memory 316 and/or processor 314 can be associated with the quantum operation component 303, where suitable.

The quantum operation component 303 can determine mapping of one or more quantum logic circuits for executing a quantum program. In one or more embodiments, the quantum operation component 303 and/or quantum processor 306 can direct the waveform generator 310 to generate one or more pulses, tones, waveforms and/or the like to affect one or more qubits 307, such as in response to a quantum job request 324.

The waveform generator 310 can generally cause the quantum processor 306 to perform one or more quantum processes, calculations and/or measurements by creating a suitable electro-magnetic signal. For example, the waveform generator 310 can operate one or more qubit effectors, such as qubit oscillators, harmonic oscillators, pulse generators and/or the like to cause one or more pulses to stimulate and/or manipulate the state(s) of the one or more qubits 307 comprised by the quantum system 301.

The quantum processor 306 and a portion or all of the waveform generator 310 can be contained in a cryogenic environment, such as generated by a cryogenic environment 317, such as effected by a dilution refrigerator. Indeed, a signal can be generated by the waveform generator 310 to affect one or more of the plurality of qubits 307. Where the plurality of qubits 307 are superconducting qubits, cryogenic temperatures, such as about 4K or lower, can be employed for function of these physical qubits. Accordingly, one or more elements of the readout electronics 312 also can be constructed to perform at such cryogenic temperatures.

The readout electronics 312, or at least a portion thereof, can be contained in the cryogenic environment 317, such as for reading a state, frequency and/or other characteristic of qubit, excited, decaying or otherwise.

Further, the aforementioned description(s) refer(s) to the operation of a single set of instructions run on a single qubit. However, scaling can be achieved. For example, instructions can be calculated, transmitted, employed and/or otherwise used relative to one or more qubits (e.g., non-neighbor qubits) in parallel with one another, one or more quantum circuits in parallel with one another, and/or one or more qubit mappings in parallel with one another.

Discussion now turns back to FIGS. 2 and 5 and to the processes defining an iteration of use of the ansatz and hardware pairing system 202, including the validated (e.g., including trained) ML model 218, to generate the outputs 240 comprising one or more sets of predicted ansatz-hardware pairings based on a set of inputs 230 (e.g., at step 544 of FIG. 5).

This use of the ansatz and hardware pairing system 202 can comprise the ML model 118 comparing the inputs 230 to the database 232 of stored ansatz-hardware pairings. Based on the comparing, the ML model 118 can generate one or more ansatz-hardware pairings.

The generating component 114 can determine a prediction comprising the ansatz-hardware pairings, or a subset thereof, based on the output of the ML model 118. The predicted set comprises data correlating to an ansatz name, ansatz metrics and hardware metrics. The prediction also can comprise data correlating to at least a prediction accuracy of an output of the quantum circuit to be performed on the quantum hardware of the ansatz-hardware pairing.

For example, as illustrated at FIG. 7, the predicted set 740 represents these predicted ansatz-hardware pairings.

Using the predicted set of ansatz-hardware pairings, the generating component 114 can perform a cost computation 742 to add to the data by providing an additional aspect for comparison of the ansatz-hardware pairings of the predicted set (e.g., predicted set 740) to one another. For example, the cost of running a program on a quantum computer can be computed by calculating a qubit-time resource. A qubit-time resource refers to the total time required for running the circuits multiplied by the total number of qubits used. Given the dataset size, the total number of circuits to be run on the quantum computer can be determined, and given the total time required to run these circuits and the number of qubits used, a cost can be output. This cost can vary if there is reservation of hardware, odd queuing delay, and/or the hardware is down for maintenance and/or not available (e.g., due to an issue during operation).

Additionally, the ranking component 220 can obtain the predicted set of ansatz-hardware pairings (e.g., predicted set 740) and perform a ranking 546 of the ansatz-hardware pairings based on any one or more different ranking aspects, such as number of shots to be run, monetary cost, topology, machine type and/or output accuracy.

The output component 222 can subsequently output the ranked set 750 to a device of a target system 250 associated with a user entity, administrator entity, etc. In one or more embodiments, the output component 222 can output the data in a form of a dashboard where the ranked set 750 is sortable by different categories (e.g., the ranking aspects). These insights through ranking can allow a user entity evaluating the predicted ansatz-hardware pairings to determine a best trade off based on user entity-based subjective criteria. That is, a balance of these trade off aspects can be identified automatically, based on selected input to the system and/or by the user entity.

Put another way, the ansatz and hardware pairing system 202 can offer the user entity a set of pairings compatible with the inputs 230 provided but identified by the various ranking aspects to allow the user entity to choose between best accuracy, best hardware metrics and/or best budget, based on the pairings predicted. User entities can thus be able to better estimate their costs involved to be able to solve their applications, that with existing frameworks.

Further, use of the predicted pairings in the form of quantum circuits operated on the quantum system 301 can allow for efficient use of the quantum hardware thereof, which can reduce the load on the hardware and/or allow for more productive use of the hardware. That is, in one or more embodiments, for a selected pairing of the pairings of the ranked set 750, a quantum circuit can be generated from the pairing (e.g., from the ansatz and hardware metrics thereof) by the generating component 214 or by any other component of the classical ansatz and hardware pairing system 202. This quantum circuit can be obtained by the quantum system 301 in the form of a quantum job request 224. The quantum operation component 303 can then execute operation of the quantum circuit using the waveform generator 310 and quantum processor 306 on qubits of the quantum processor 306.

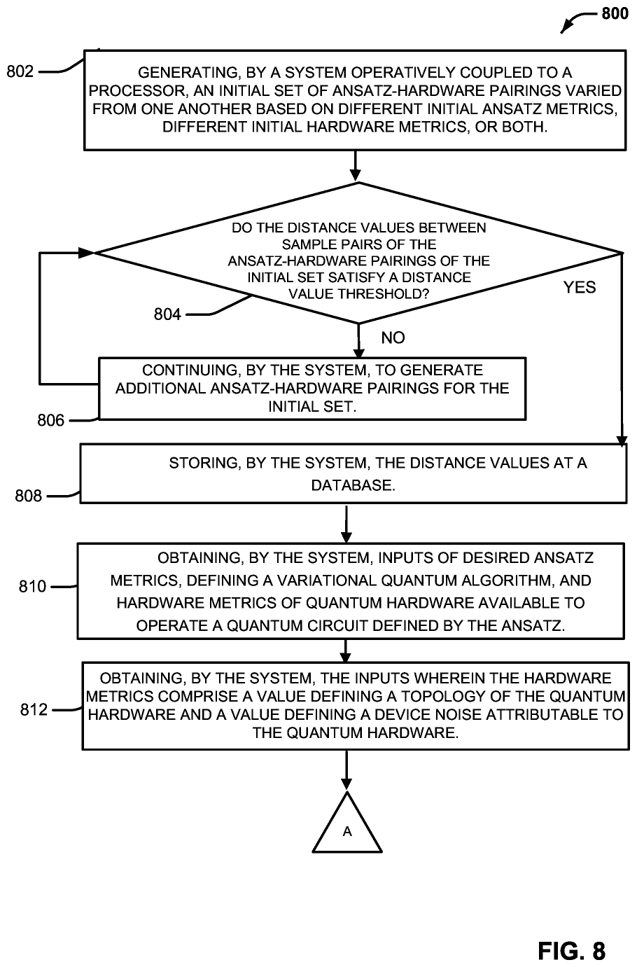

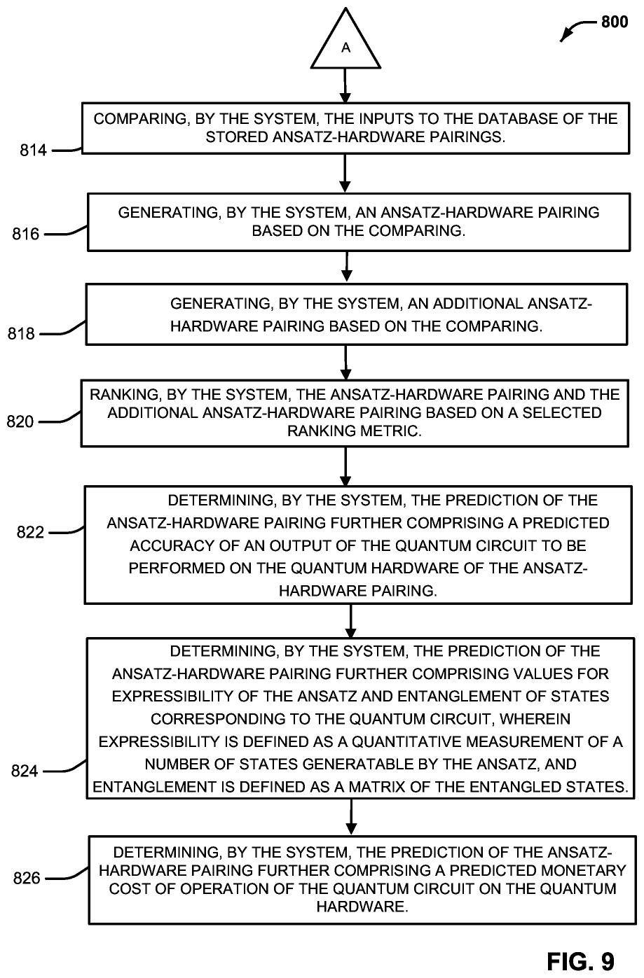

Referring next to FIGS. 8 and 9, to provide a summary of the various processes defined above for generation of the database 232, training of the ML model 218 that uses the database 232, and finally to use of the ansatz and hardware pairing system 202 to provide one or more ansatz-hardware pairings to aid in solving a problem that corresponds to the set of inputs 230, illustrated is a flow diagram. The flow diagram illustrates an example, non-limiting method 800 that can provide a process to generate an ansatz-hardware pairing for execution of a quantum circuit and a quantum hardware of the ansatz-hardware pairing, in accordance with one or more embodiments described herein, such as the non-limiting system 200 of FIG. 2. While the non-limiting method 800 is described relative to the non-limiting system 200 of FIG. 2, the non-limiting method 800 can be applicable also to other systems described herein, such as the non-limiting systems 100 and 300 of FIGS. 1 and 3. Repetitive description of like elements and/or processes employed in respective embodiments is omitted for sake of brevity.

At 802, the non-limiting method 800 can comprise generating, by a system operatively coupled to a processor (e.g., training component 216), an initial set of ansatz-hardware pairings varied from one another based on different initial ansatz metrics, different initial hardware metrics, or both.

At 804, the non-limiting method 800 can comprise determining, by the system (e.g., training component 216), whether distance values between sample pairs of the ansatz-hardware pairings of the initial set satisfy a distance value threshold.

If no, at 806, the non-limiting method 800 can continuing, by the system (e.g., training component 216), to generate additional ansatz-hardware pairings for the initial set.

If yes, at 808, the non-limiting method 800 can comprise storing, by the system (e.g., training component 216), the distance values at a database.

At 810, the non-limiting method 800 can comprise obtaining, by the system (e.g., obtaining component 212), inputs of desired ansatz metrics, defining a variational quantum algorithm, and hardware metrics of quantum hardware available to operate a quantum circuit defined by the ansatz.

At 812, the non-limiting method 800 can comprise obtaining, by the system (e.g., obtaining component 212), the inputs wherein the hardware metrics comprise a value defining a topology of the quantum hardware and a value defining a device noise attributable to the quantum hardware.

At 814, the non-limiting method 800 can comprise comparing, by the system (e.g., machine learning model 218), the inputs to the database of the stored ansatz-hardware pairings.

At 816, the non-limiting method 800 can comprise generating, by the system (e.g., machine learning model 218), an ansatz-hardware pairing based on the comparing.

At 818, the non-limiting method 800 can comprise generating, by the system (e.g., machine learning model 218), an additional ansatz-hardware pairing based on the comparing.

At 820, the non-limiting method 800 can comprise ranking, by the system (e.g., ranking component 220), the ansatz-hardware pairing and the additional ansatz-hardware pairing based on a selected ranking metric.

At 822, the non-limiting method 800 can comprise determining, by the system (e.g., generating component 214), the prediction of the ansatz-hardware pairing further comprising a predicted accuracy of an output of the quantum circuit to be performed on the quantum hardware of the ansatz-hardware pairing.

At 824, the non-limiting method 800 can comprise determining, by the system (e.g., generating component 214), the prediction of the ansatz-hardware pairing further comprising values for expressibility of the ansatz and entanglement of states corresponding to the quantum circuit, wherein expressibility is defined as a quantitative measurement of a number of states generatable by the ansatz, and entanglement is defined as a matrix of the entangled states.

At 826, the non-limiting method 800 can comprise determining, by the system (e.g., generating component 214), the prediction of the ansatz-hardware pairing further comprising a predicted monetary cost of operation of the quantum circuit on the quantum hardware.

### Additional Summary

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. In addition, the computer-implemented and non-computer-implemented methodologies could alternatively be represented as a series of interrelated states via a state diagram or events. Additionally, the computer-implemented methodologies described hereinafter and throughout this specification are capable of being stored on an article of manufacture for transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

In summary, one or more systems, computer program products and/or computer-implemented methods of use provided herein relate to a process to generate an ansatz-hardware pairing. A system can comprise a memory that stores computer executable components, and a processor that executes the computer executable components stored in the memory, wherein the computer executable components can comprise a machine learning model that compares the inputs to a database of stored ansatz-hardware pairings and that generates the ansatz-hardware pairing based on the comparing, wherein the inputs comprise desired ansatz metrics, defining a variational quantum algorithm, and hardware metrics of quantum hardware available to operate a quantum circuit defined by the ansatz, and a generating component that determines a prediction comprising the ansatz-hardware pairing, wherein the prediction comprises a predicted accuracy of an output of the quantum circuit to be performed on the quantum hardware of the ansatz-hardware pairing.

A benefit of the above-indicated system, computer-implemented method and/or computer program product can be allowing for an automatic process for identifying both ansatz metrics and hardware metrics that pair well, and thus result in a chosen trade off of hardware, number of shots to run, monetary cost and/or accuracy of output. That is, varied output, e.g., pairing predictions, can be provided, and from these outputs, a pairing can be identified for operation that satisfies selected requirements for operation among the available hardware, number of shots to run, monetary cost and/or accuracy of output. A balance of these trade off aspects can be identified automatically, based on selected input to the system and/or by a user entity.

As used herein, accuracy of results can refer to results as compared to simulator results (e.g., that are free of noise). That is, all quantum machines inherently produce some level of device-initiated noise. This noise can be altered by a quantum circuit being operation on a respective quantum machine. The resultant noise can affect overall amount of noise comprised by the output and error in the output, e.g., as compared to a noise-free operation.

Indeed, determining a good match of hardware for an ansatz can be difficult. Even where parameters of a VQA are well-chosen for operation of the ansatz itself, such parameters themselves often do not match well with a chosen hardware configuration (e.g., hardware configuration on which the VQA is chosen to be operated as a quantum circuit based on the VQA). As such, a benefit of the above-indicated system, computer-implemented method and/or computer program product can be output of at least one ansatz-hardware pairing prediction based on available input to the above-indicated system, computer-implemented method and/or computer program product.

For example, a user entity can input ansatz metrics such as VQA parameters, chosen quantum gates for a quantum circuit defined by the VQA and/or a proposed qubit mapping. The user entity further can input hardware metrics for one or more machines that can be available for operation of the quantum circuit. As used herein, availability can be based on available operation time, allowable level of access, cost to access (e.g., budget), etc. Indeed, even with minimal access to one or more quantum devices/systems, the one or more quantum devices/systems can have plural available configurations, and the one or more embodiments described herein can enable pairing outputs that can result in a more efficient use of the quantum hardware, reduced load on the quantum hardware, increased productivity of experiments by a user entity and/or increased number of experiments operated by a user entity.

Indeed, in view of the one or more embodiments described herein, a practical application of the systems, computer-implemented methods and/or computer program products described herein can be ability to translate input ansatz metrics and hardware metrics into an output of one or more ansatz-hardware pairings. These pairings can be ranked or chosen based on a variety of trade off aspects such as monetary cost, number shots to operate, hardware topology and/or other hardware configuration. As a result, of hardware metrics available for operation of a quantum circuit based on an ansatz, a corresponding pairing can allow for improved operation of the quantum system itself. That is, an ansatz can be matched to a hardware configuration on which the ansatz runs well, e.g., with reduced noise and/or error as compared to operation one or more other hardware configurations. Put another way, by automatically determining an ansatz-hardware pairing, a more efficient use of the quantum hardware, a reduced load on the quantum hardware, an increased productivity of efficient and high accuracy experiments, and/or an increased number of experiments operated by a user entity can be obtained. Indeed, a balance of two or more of these benefits can be obtained by provision of two or more ansatz-hardware pairing from which a desired pairing satisfying such balance can be selected.

This can be a useful and practical application of computers, thus providing enhanced (e.g., improved and/or optimized) operation of a quantum logic circuit of a target quantum system. Overall, such computerized tools can constitute a concrete and tangible technical improvement in the field of hardware selection for quantum computing and/or quantum computing more generally.

Furthermore, one or more embodiments described herein can be employed in a real-world system based on the disclosed teachings. For example, one or more embodiments described herein can function with a quantum system that can receive as input a quantum job request comprising a quantum circuit to be operated on the quantum system as described herein, and can measure a real-world qubit state of one or more qubits, such as superconducting qubits, of the quantum system, by executing the quantum circuit at some level of the quantum system.

Moreover, a device and/or method described herein can be implemented in one or more domains to enable scaled pairing of ansatzes and hardware configurations. Indeed, use of a system as described herein can be scalable, such as where plural sets of input data can be employed to output plural different ansatz-hardware pairings at least partially at a same time as one another. The ansatz-hardware pairings can be predicted for use at a same target system or different target systems.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can be, in one or more embodiments, inherently and/or inextricably tied to computer technology and cannot be implemented outside of a computing environment. For example, one or more processes performed by one or more embodiments described herein can more efficiently, and even more feasibly, provide program and/or program instruction execution, such as relative to source code translation, as compared to existing systems and/or techniques. Systems, computer-implemented methods and/or computer program products providing performance of these processes are of great utility in the fields of source code execution, such as in connection with quantum computing and superconducting quantum systems and cannot be equally practicably implemented in a sensible way outside of a computing environment.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively provide output pairings based on consideration of plural variables as a machine learning model of one or more embodiments described herein can provide this process. Moreover, neither can the human mind nor a human with pen and paper conduct one or more of these processes, as conducted by one or more embodiments described herein. For an additional example, a human, or even thousands of humans, cannot efficiently, accurately and/or effectively automatically perform quantum circuit encoding, load a quantum register, perform quantum calculations, generate a waveform and/or measure a state of qubit as the one or more embodiments described herein can provide these processes. Moreover, neither can the human mind nor a human with pen and paper conduct one or more of these processes, as conducted by one or more embodiments described herein.

In one or more embodiments, one or more of the processes described herein can be performed by one or more specialized computers (e.g., a specialized processing unit, a specialized classical computer, a specialized quantum computer, a specialized hybrid classical/quantum system and/or another type of specialized computer) to execute defined tasks related to the one or more technologies describe above. One or more embodiments described herein and/or components thereof can be employed to solve new problems that arise through advancements in technologies mentioned above, employment of quantum computing systems, cloud computing systems, computer architecture and/or another technology.

One or more embodiments described herein can be fully operational towards performing one or more other functions (e.g., fully powered on, fully executed and/or another function) while also performing one or more of the one or more operations described herein.

To provide additional summary, a listing of embodiments and features thereof is next provided.

A system, comprising: a memory that stores computer executable components; and a processor that executes the computer executable components stored in the memory, wherein the computer executable components comprise: a machine learning model that compares inputs to a database of stored ansatz-hardware pairings and that generates the ansatz-hardware pairing based on the comparing, wherein the inputs comprise desired ansatz metrics, defining a variational quantum algorithm, and hardware metrics of quantum hardware available to operate a quantum circuit defined by the ansatz; and a generating component that determines a prediction comprising the ansatz-hardware pairing, wherein the prediction comprises a predicted accuracy of an output of the quantum circuit to be performed on the quantum hardware of the ansatz-hardware pairing.

The system of the preceding paragraph, wherein the prediction further comprises values for expressibility of the ansatz and entanglement of states corresponding to the quantum circuit, wherein expressibility is defined as a quantitative measurement of a number of states generatable by the ansatz, and entanglement is defined as a matrix of the entangled states.

The system of any preceding paragraph, wherein the hardware metrics comprise a value defining a topology of the quantum hardware and a value defining a device noise attributable to the quantum hardware.

The system of any preceding paragraph, wherein the prediction further comprises a predicted monetary cost of operation of the quantum circuit on the quantum hardware.

The system of any preceding paragraph, wherein the machine learning model further generates an additional ansatz-hardware pairing based on the inputs, and wherein the computer executable components further comprise a ranking component that ranks the ansatz-hardware pairing and the additional ansatz-hardware pairing based on a selected ranking metric.

The system of any preceding paragraph, wherein the computer executable components further comprise a training component that generates an initial set of ansatz-hardware pairings varied from one another based on different initial ansatz metrics, different initial hardware metrics, or both, wherein the training component determines distance values between sample pairs of the ansatz-hardware pairings of the initial set and continues to generate additional ansatz-hardware pairings for the initial set where the distance values fail to satisfy a distance value threshold.

The system of any preceding paragraph, wherein the training component further directs evaluation of the ansatz-hardware pairings of the initial set on quantum hardware defined by the initial hardware metrics or on a simulator defined by the initial hardware metrics, and wherein the training component stores output accuracies corresponding to the operated ansatz-hardware pairings at the database with the respective initial ansatz metrics and initial hardware metrics.

A computer-implemented method, comprising: comparing, by a machine learning model of a system operatively coupled to a processor, inputs to a database of stored ansatz-hardware pairings, wherein the inputs comprise desired ansatz metrics, defining a variational quantum algorithm, and hardware metrics of quantum hardware available to operate a quantum circuit defined by the ansatz; generating, by the machine learning model, the ansatz-hardware pairing based on the comparing; and determining, by the system, a prediction comprising the ansatz-hardware pairing, wherein the prediction comprises a predicted accuracy of an output of the quantum circuit to be performed on the quantum hardware of the ansatz-hardware pairing.

The computer-implemented method of the preceding paragraph, wherein the prediction further comprises values for expressibility of the ansatz and entanglement of states corresponding to the quantum circuit, wherein expressibility is defined as a quantitative measurement of a number of states generatable by the ansatz, and entanglement is defined as a matrix of the entangled states.

The computer-implemented method of any preceding paragraph, wherein the hardware metrics comprise a value defining a topology of the quantum hardware and a value defining a device noise attributable to the quantum hardware.

The computer-implemented method of any preceding paragraph, wherein the prediction further comprises a predicted monetary cost of operation of the quantum circuit on the quantum hardware.

The computer-implemented method of any preceding paragraph, wherein the machine learning model further generates an additional ansatz-hardware pairing based on the inputs, and wherein the computer-implemented method further comprises ranking, by the system, the ansatz-hardware pairing and the additional ansatz-hardware pairing based on a selected ranking metric.

The computer-implemented method of any preceding paragraph, further comprising: generating, by the system, an initial set of ansatz-hardware pairings varied from one another based on different initial ansatz metrics, different initial hardware metrics, or both; and determining, by the system, distance values between sample pairs of the ansatz-hardware pairings of the initial set and continues to generate additional ansatz-hardware pairings for the initial set where the distance values fail to satisfy a distance value threshold.

The computer-implemented method of any preceding paragraph, further comprising: directing, by the system, evaluation of the ansatz-hardware pairings of the initial set on quantum hardware defined by the initial hardware metrics or on a simulator defined by the initial hardware metrics, and outputting, by the system, accuracies corresponding to the operated ansatz-hardware pairings at the database with the respective initial ansatz metrics and initial hardware metrics.

A computer program product facilitating a process to generate an ansatz-hardware pairing, the computer program product comprising a computer readable storage medium having program instructions embodied therewith, the program instructions executable by a processor to cause the processor to: compare, by a machine learning model operatively coupled to the processor, inputs to a database of stored ansatz-hardware pairings, wherein the inputs comprise desired ansatz metrics, defining a variational quantum algorithm, and hardware metrics of quantum hardware available to operate a quantum circuit defined by the ansatz; generate, by the machine learning model, the ansatz-hardware pairing based on the comparing; and determine, by the processor, a prediction comprising the ansatz-hardware pairing, wherein the prediction comprises a predicted accuracy of an output of the quantum circuit to be performed on the quantum hardware of the ansatz-hardware pairing.

The computer program product of the preceding paragraph, wherein the prediction further comprises values for expressibility of the ansatz and entanglement of states corresponding to the quantum circuit, wherein expressibility is defined as a quantitative measurement of a number of states generatable by the ansatz, and entanglement is defined as a matrix of the entangled states.

The computer program product of any preceding paragraph, wherein the hardware metrics comprise a value defining a topology of the quantum hardware and a value defining a device noise attributable to the quantum hardware.

The computer program product of any preceding paragraph, wherein the machine learning model further generates an additional ansatz-hardware pairing based on the inputs, and

wherein the program instructions are further executable by the processor to cause the processor to rank, by the processor, the ansatz-hardware pairing and the additional ansatz-hardware pairing based on a selected ranking metric.

The computer program product of any preceding paragraph, wherein the program instructions are further executable by the process to cause the processor to:
generate, by the processor, an initial set of ansatz-hardware pairings varied from one another based on different initial ansatz metrics, different initial hardware metrics, or both; and determine, by the processor, distance values between sample pairs of the ansatz-hardware pairings of the initial set and continues to generate additional ansatz-hardware pairings for the initial set where the distance values fail to satisfy a distance value threshold.

The computer program product of any preceding paragraph, wherein the program instructions are further executable by the process to cause the processor to: direct, by the processor, evaluation of the ansatz-hardware pairings of the initial set on quantum hardware defined by the initial hardware metrics or on a simulator defined by the initial hardware metrics, and output, by the processor, accuracies corresponding to the operated ansatz-hardware pairings at the database with the respective initial ansatz metrics and initial hardware metrics.

### Computing Environment Description

Turning next to FIG. 10, a detailed description is provided of additional context for the one or more embodiments described herein at FIGS. 1-9.

FIG. 10 and the following discussion are intended to provide a brief, general description of a suitable computing environment 1000 in which one or more embodiments described herein at FIGS. 1-9 can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as translation of an original source code based on a configuration of a target system by the ansatz-hardware generation code 1080. In addition to block 1080, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1080, as identified above), peripheral device set 1014 (including user interface (UI), device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in block 1080 in persistent storage 1013.

COMMUNICATION FABRIC 1011 is the signal conduction paths that allow the various components of computer 1001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid state storage devices. Operating system 1022 may take several forms, such as various known proprietary operating systems or open source Portable Operating System Interface type operating systems that employ a kernel. The code included in block 1080 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001) and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

REMOTE SERVER 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

### Additional Closing Information

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented in combination with one or more other program modules. Generally, program modules include routines, programs, components, data structures and/or the like that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), microprocessor-based or programmable consumer and/or industrial electronics and/or the like. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

1. A system, comprising:
a memory that stores computer executable components; and
a processor that executes the computer executable components stored in the memory, wherein the computer executable components comprise:
a machine learning model that compares inputs to a database of stored ansatz-hardware pairings and that generates the ansatz-hardware pairing based on the comparing,
wherein the inputs comprise desired ansatz metrics, defining a variational quantum algorithm, and hardware metrics of quantum hardware available to operate a quantum circuit defined by the ansatz; and
a generating component that determines a prediction comprising the ansatz-hardware pairing,
wherein the prediction comprises a predicted accuracy of an output of the quantum circuit to be performed on the quantum hardware of the ansatz-hardware pairing.

2. The system of claim 1, wherein the prediction further comprises values for expressibility of the ansatz and entanglement of states corresponding to the quantum circuit, wherein expressibility is defined as a quantitative measurement of a number of states generatable by the ansatz, and entanglement is defined as a matrix of the entangled states.

3. The system of claim 1, wherein the hardware metrics comprise a value defining a topology of the quantum hardware and a value defining a device noise attributable to the quantum hardware.

4. The system of claim 1, wherein the prediction further comprises a predicted monetary cost of operation of the quantum circuit on the quantum hardware.

5. The system of claim 1, wherein the machine learning model further generates an additional ansatz-hardware pairing based on the inputs, and
wherein the computer executable components further comprise a ranking component that ranks the ansatz-hardware pairing and the additional ansatz-hardware pairing based on a selected ranking metric.

6. The system of claim 1, wherein the computer executable components further comprise
a training component that generates an initial set of ansatz-hardware pairings varied from one another based on different initial ansatz metrics, different initial hardware metrics, or both,
wherein the training component determines distance values between sample pairs of the ansatz-hardware pairings of the initial set and continues to generate additional ansatz-hardware pairings for the initial set where the distance values fail to satisfy a distance value threshold.

7. The system of claim 6, wherein the training component further directs evaluation of the ansatz-hardware pairings of the initial set on quantum hardware defined by the initial hardware metrics or on a simulator defined by the initial hardware metrics, and
wherein the training component stores output accuracies corresponding to the operated ansatz-hardware pairings at the database with the respective initial ansatz metrics and initial hardware metrics.

8. A computer-implemented method, comprising:
comparing, by a machine learning model of a system operatively coupled to a processor, inputs to a database of stored ansatz-hardware pairings,
wherein the inputs comprise desired ansatz metrics, defining a variational quantum algorithm, and hardware metrics of quantum hardware available to operate a quantum circuit defined by the ansatz;
generating, by the machine learning model, the ansatz-hardware pairing based on the comparing; and
determining, by the system, a prediction comprising the ansatz-hardware pairing,
wherein the prediction comprises a predicted accuracy of an output of the quantum circuit to be performed on the quantum hardware of the ansatz-hardware pairing.

9. The computer-implemented method of claim 8, wherein the prediction further comprises values for expressibility of the ansatz and entanglement of states corresponding to the quantum circuit, wherein expressibility is defined as a quantitative measurement of a number of states generatable by the ansatz, and entanglement is defined as a matrix of the entangled states.

10. The computer-implemented method of claim 8, wherein the hardware metrics comprise a value defining a topology of the quantum hardware and a value defining a device noise attributable to the quantum hardware.

11. The computer-implemented method of claim 8, wherein the prediction further comprises a predicted monetary cost of operation of the quantum circuit on the quantum hardware.

12. The computer-implemented method of claim 8, wherein the machine learning model further generates an additional ansatz-hardware pairing based on the inputs, and
wherein the computer-implemented method further comprises ranking, by the system, the ansatz-hardware pairing and the additional ansatz-hardware pairing based on a selected ranking metric.

13. The computer-implemented method of claim 8, further comprising:
generating, by the system, an initial set of ansatz-hardware pairings varied from one another based on different initial ansatz metrics, different initial hardware metrics, or both; and
determining, by the system, distance values between sample pairs of the ansatz-hardware pairings of the initial set and continues to generate additional ansatz-hardware pairings for the initial set where the distance values fail to satisfy a distance value threshold.

14. The computer-implemented method of claim 13, further comprising:
directing, by the system, evaluation of the ansatz-hardware pairings of the initial set on quantum hardware defined by the initial hardware metrics or on a simulator defined by the initial hardware metrics, and
outputting, by the system, accuracies corresponding to the operated ansatz-hardware pairings at the database with the respective initial ansatz metrics and initial hardware metrics.

15. A computer program product facilitating a process to generate an ansatz-hardware pairing, the computer program product comprising a computer readable storage medium having program instructions embodied therewith, the program instructions executable by a processor to cause the processor to:
compare, by a machine learning model operatively coupled to the processor, inputs to a database of stored ansatz-hardware pairings,
wherein the inputs comprise desired ansatz metrics, defining a variational quantum algorithm, and hardware metrics of quantum hardware available to operate a quantum circuit defined by the ansatz;
generate, by the machine learning model, the ansatz-hardware pairing based on the comparing; and
determine, by the processor, a prediction comprising the ansatz-hardware pairing,
wherein the prediction comprises a predicted accuracy of an output of the quantum circuit to be performed on the quantum hardware of the ansatz-hardware pairing.

16. The computer program product of claim 15, wherein the prediction further comprises values for expressibility of the ansatz and entanglement of states corresponding to the quantum circuit, wherein expressibility is defined as a quantitative measurement of a number of states generatable by the ansatz, and entanglement is defined as a matrix of the entangled states.

17. The computer program product of claim 15, wherein the hardware metrics comprise a value defining a topology of the quantum hardware and a value defining a device noise attributable to the quantum hardware.

18. The computer program product of claim 15, wherein the machine learning model further generates an additional ansatz-hardware pairing based on the inputs, and
wherein the program instructions are further executable by the processor to cause the processor to rank, by the processor, the ansatz-hardware pairing and the additional ansatz-hardware pairing based on a selected ranking metric.

19. The computer program product of claim 15, wherein the program instructions are further executable by the process to cause the processor to:
generate, by the processor, an initial set of ansatz-hardware pairings varied from one another based on different initial ansatz metrics, different initial hardware metrics, or both; and
determine, by the processor, distance values between sample pairs of the ansatz-hardware pairings of the initial set and continues to generate additional ansatz-hardware pairings for the initial set where the distance values fail to satisfy a distance value threshold.

20. The computer program product of claim 19, wherein the program instructions are further executable by the process to cause the processor to:
direct, by the processor, evaluation of the ansatz-hardware pairings of the initial set on quantum hardware defined by the initial hardware metrics or on a simulator defined by the initial hardware metrics, and
output, by the processor, accuracies corresponding to the operated ansatz-hardware pairings at the database with the respective initial ansatz metrics and initial hardware metrics.
